(19) United States
(12) Patent Application Publication
(10) Pub. No.: US 2014/0318343 A1
(43) Pub. Date: Oct. 30, 2014

(54) Punching Machine

(71) Applicant: Chun Yuan Chang, Taichung City (TW)

(72) Inventor: Chun Yuan Chang, Taichung City (TW)

(21) Appl. No.: 13/869,035

(22) Filed: Apr. 24, 2013

(51) Int. Cl. B26F 1/04; B26F 1/14; B26D 3/10

(52) U.S. Cl. CPC B26F 1/04; B26D 3/10; B26F 1/14
USPC 83/670; 30/364; 83/686

(57) ABSTRACT

A punching machine contains a base, a bottom cover, a pressing seat, a slot, and a stopping recess. The punching machine also contains a holder, and a limiting groove has a press device mounted therein and fixed in an imitation notch of the holder, the press device has a first positioning piece, at least one spacing block, a second positioning piece, and a third positioning piece. The holder has at least one opening, the first positioning piece has at least one first pore, the second positioning piece has at least one second pore, and the third positioning piece has at least one third pore. A respective one of at least one column has a shape-varying cross section so as to matching with a shape of each second pore and each third pore. Also, the forcing controller further has a locating element.

### FIELD OF THE INVENTION

The present invention relates to a punching machine which is capable of punching at least one hole with a varying shape.

### BACKGROUND OF THE INVENTION

A conventional punching machine can only punch one hole on the workpiece. Accordingly, an improved punching machine is developed to punch a plurality of holes on the workpiece. However, such an improved punching machine can merely punch the plurality of holes with a same shape.

### SUMMARY OF THE INVENTION

The primary object of the present invention is to provide a punching machine which is capable of punching at least one hole with a varying shape.

To obtain the above objectives, a punching machine provided by the present invention contains: a base, a bottom cover disposed on a bottom end of the base, a pressing seat formed on a rear side of the base, a slot defined between a bottom end of a front side of the pressing seat and the base, a stopping recess formed on the base and located in front of the slot.

The stopping recess has an adjustable scale stopper received in the stopping recess.

The punching machine also comprises a holder mounted in the base and located under the pressing seat, wherein the pressing seat has a limiting groove defined thereon, and two locking plates are disposed on two sides of the pressing seat, wherein each locking plates has a first hole, and the holder has an limitation notch defined thereon and corresponding to the limiting groove of the pressing seat and has at least one opening.

The limiting groove has a press device mounted therein and fixed in the imitation notch of the holder, the press device has a first positioning piece disposed in the limitation notch of the holder and has at least one separating block, at least one spacing block, a second positioning piece, and a third positioning piece, wherein the at least one spacing block, the second positioning piece, and the third positioning piece are placed on the first positioning piece.

The first positioning piece has at least one first orifice defined thereon, a respective one of the at least one second positioning piece has an aperture defined thereon, the second positioning piece has at least one second orifice defined thereon, and the third positioning piece has at least one third orifice defined thereon, such that at least screw bolt is inserted through the at least one third orifice, the at least one second orifice, at least three apertures, and the at least one first orifice to screw with at least one first nut, such that the third positioning piece, the second positioning piece the first positioning piece are connected together.

The holder has at least one opening, the first positioning piece has at least one first pore, the second positioning piece has at least one second pore, and the third positioning piece has at least one third pore.

A respective one of at least one column has a shape-varying cross section so as to matching with a shape of each second pore and each third pore and is inserted between the at least one second pore of the second positioning piece and the at least one third pore of the third positioning piece, wherein a respective one of the at least one column has a fixing shaft inserted thereon and has a defining ring fitted on a lower side thereof under the fixing shaft, the defining ring has an eyelet with a varying shape for matching with a shape of a cross section of each column and has a resilient element fitted on a lower side thereof, wherein the each column extends out of a respective one of the at least one third pore.

Also, a forcing controller is defined between the two locking plates, and the forcing controller has a second hole corresponding to two first holes of the two locking plates and is connected with the two locking plates by inserting a screwing rod through the second hole and the two first holes and by screwing the screwing rod with a second nut.

The screwing rod has a trench formed around a central section thereof, and the forcing controller also has an handle extending outwardly from a front end thereof and has an abutting member, the forcing controller further has a locating element.

### BRIEF DESCRIPTION OF THE DRAWINGS

FIG. 1 is a perspective view showing the assembly of a punching machine according to the present invention.

FIG. 2 is a perspective view showing the exploded components of a main part of the punching machine according to the present invention.

FIG. 3 is a perspective view showing the exploded components of a press device of the punching machine according to the present invention.

FIG. 4 is a cross sectional view showing the operation of the punching machine according to the present invention.

FIG. 5 is another cross sectional view showing the operation of the punching machine according to the present invention.

FIG. 6 is a top plan view showing the operation of the punching machine according to the present invention.

FIG. 7 is another top plan view showing the operation of the punching machine according to the present invention.

FIG. 8 is also another top plan view showing the operation of the punching machine according to the present invention.

### DETAILED DESCRIPTION OF THE PREFERRED EMBODIMENTS

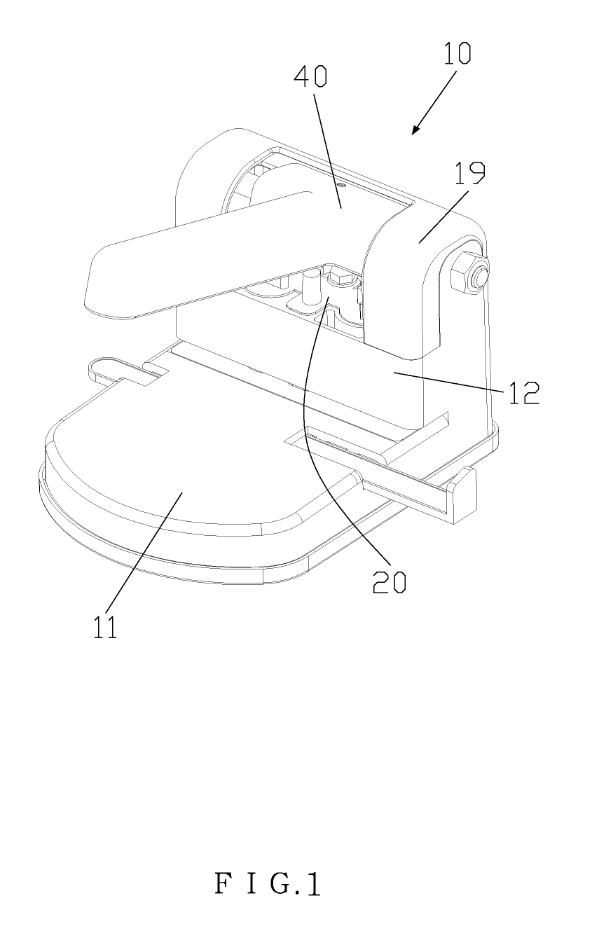

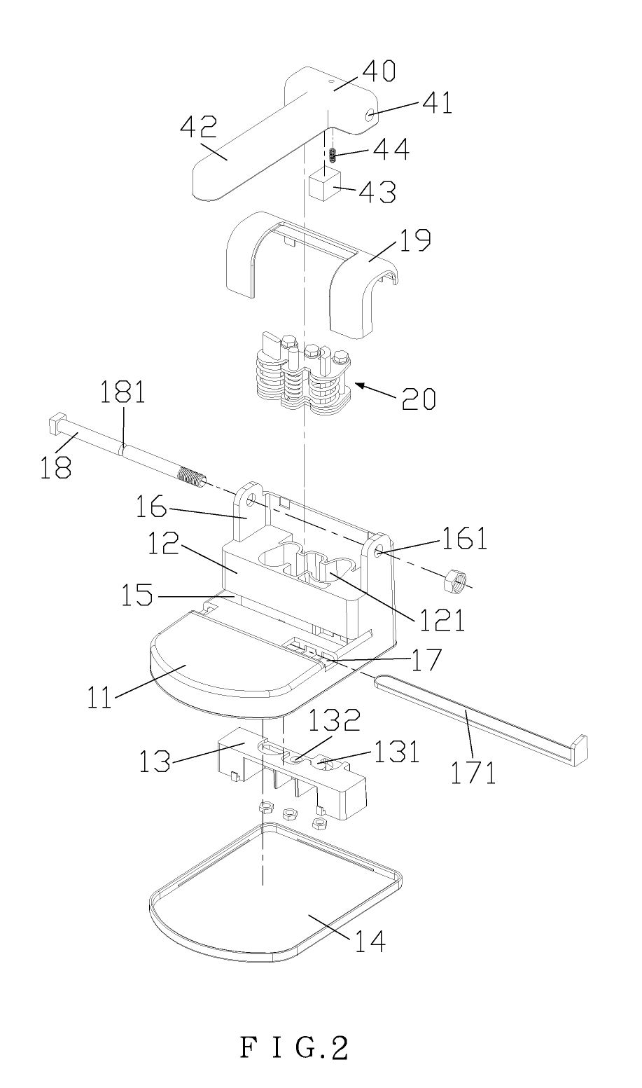

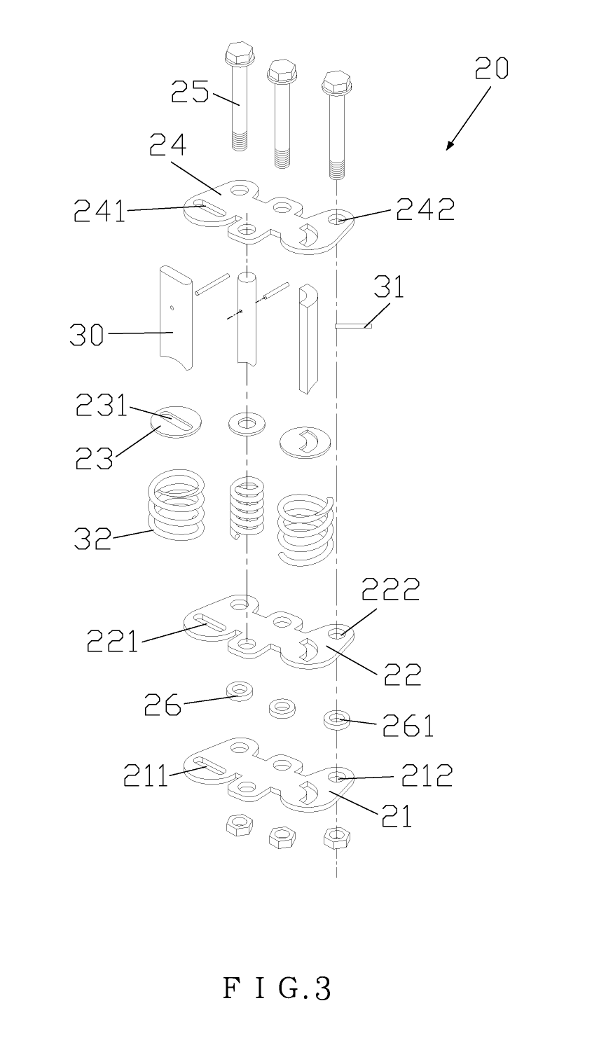

Referring to FIGS. 1-3, a punching machine 10 according to a first embodiment of the present invention comprises a base 11, a bottom cover 14 disposed on a bottom end of the base 11, a pressing seat 12 formed on a rear side of the base 11, a slot 15 defined between a bottom end of a front side of the pressing seat 12 and the base 11, a stopping recess 17 formed on the base 11 and located in front of the slot 15, wherein the stopping recess 17 has an adjustable scale stopper 171 received in the stopping recess 17. The punching machine 10 also comprises a holder 13 mounted in the base 11 and located under the pressing seat 12, wherein the pressing seat 12 has a limiting groove 121 defined thereon, and two locking plates 16 are disposed on two sides of the pressing seat 12, wherein each locking plates 16 has a first hole 161, and the holder 13 has an limitation notch 131 defined thereon and corresponding to the limiting groove 121 of the pressing seat 12; and wherein the limiting groove 121 has a press device 20 mounted therein and fixed in the imitation notch 131 of the holder 13, the press device 20 has a first positioning piece 21 disposed in the limitation notch 131 of the holder 13 and has at least one spacing block 26, a second positioning piece 22, and a third positioning piece 24, wherein the at least one spacing block 26, the second positioning piece 22, and the third positioning piece 24 are placed on the first positioning piece 21. The first positioning piece 21 has at least one first orifice 212 defined thereon, a respective one of the at least one second positioning piece 26 has an aperture 261 defined thereon, the second positioning piece 22 has at least one second orifice 222 defined thereon, and the third positioning piece 24 has at least one third orifice 242 defined thereon, such that at least screw bolt 25 is inserted through the at least one third orifice 242, the at least one second orifice 222, at least three apertures 261, and the at least one first orifice 212 to screw with at least one first nut, such that the third positioning piece 24, the second positioning piece 22, the first positioning piece 21 are connected together. In addition, the holder 13 has at least one opening 132, the first positioning piece 21 has at least one first pore 211, the second positioning piece 22 has at least one second pore 221, and the third positioning piece 24 has at least one third pore 241, and the at least one opening 132 corresponding to the at least one first pore 211, the at least one second pore 221, and the at least one third pore 241. A respective one of at least one column 30 has a shape-varying cross section so as to matching with a shape of each second pore 221 and each third pore 241 and is inserted between the at least one second pore 221 of the second positioning piece 22 and the at least one third pore 241 of the third positioning piece 240, wherein a respective one of the at least one column 30 has a fixing shaft 31 inserted thereon and has a defining ring 23 fitted on a lower side thereof under the fixing shaft 31, the defining ring 23 has an eyelet 231 with a varying shape for matching with a shape of a cross section of each column 30 and has a resilient element 32 fitted on a lower side thereof, wherein the each column 30 extends out of a respective one of the at least one third pore 241. Also, between the two locking plates 16 is defined a forcing controller 40, the forcing controller 40 has a second hole 41 corresponding to two first holes 161 of the two locking plates 16 and is connected with the two locking plates 16 by inserting a screwing rod 18 through the second hole 41 and the two first holes 161 and by screwing the screwing rod 18 with a second nut. The screwing rod 18 has a trench 181 formed around a central section thereof, and the forcing controller 40 also has an handle 42 extending outwardly from a front end thereof and has an abutting member 43 fixed on a bottom end of the forcing controller 40 and moving with the forcing controller 40 to press the each column 30. The forcing controller 40 further has a locating element 44 disposed on a position thereof where corresponds to the screwing rod 18, and an upper cover 19 is covered on the pressing seat 12.

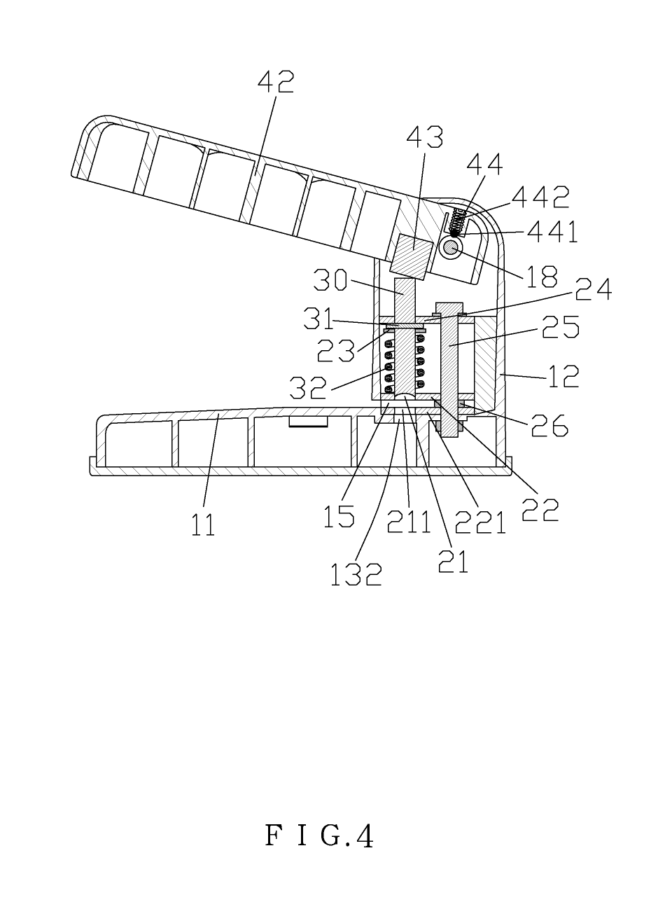

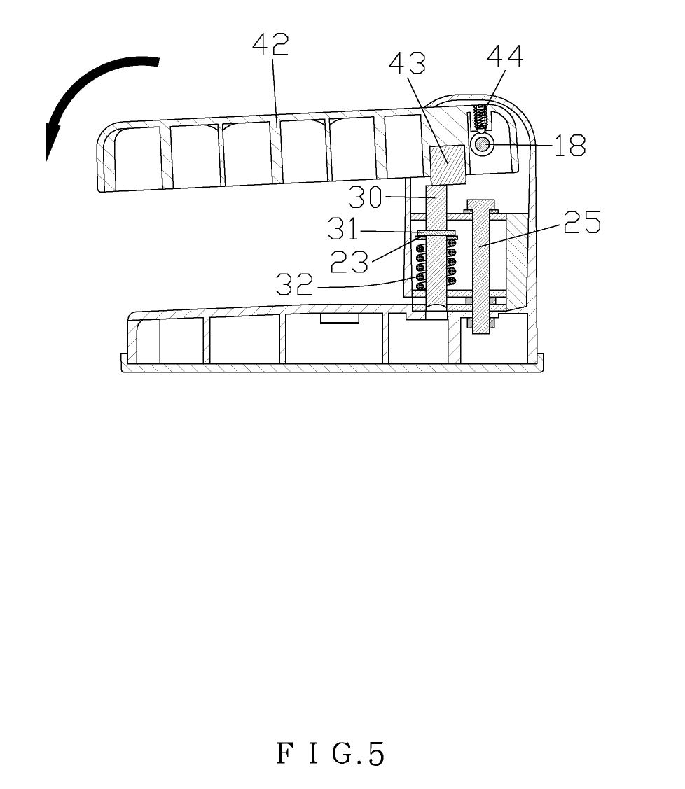

Referring further to FIGS. 4 and 5, in operation, the abutting member 43 of the forcing controller 40 abuts against one of the at least one column 30, and a workpiece is placed into the slot 15, wherein a height of the at least one separating block 26 is equal to the slot 15, such that when pressing the handle 42 downwardly, the abutting member 43 is driven by the handle 42 to press the at least one column 30 downwardly, and then the fixing shaft 31 pushes the defining ring 23 and the resilient element 32 downwardly, thereafter the at least one column 30 inserts into the at least one first pore 211 and the at least one opening 132 via the at least one second pore 221 of the second positioning piece 22 and the slot 15, thus punching a hole on the workpiece. Thereafter, after releasing the handle 42, the resilient element 32 pushes the defining ring 23 and the resilient element 32 upwardly, thus returning the at least one column 30 back to an original position.

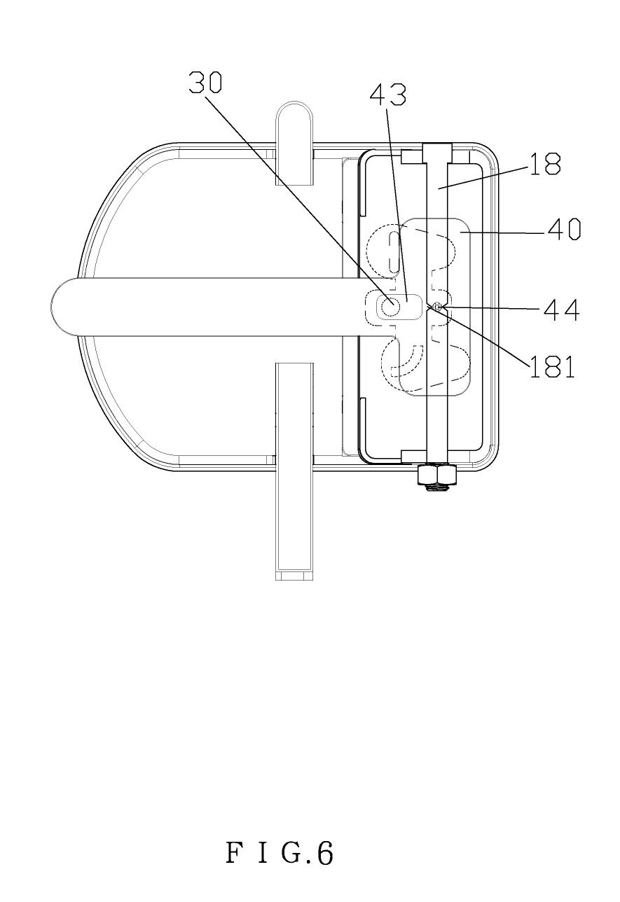

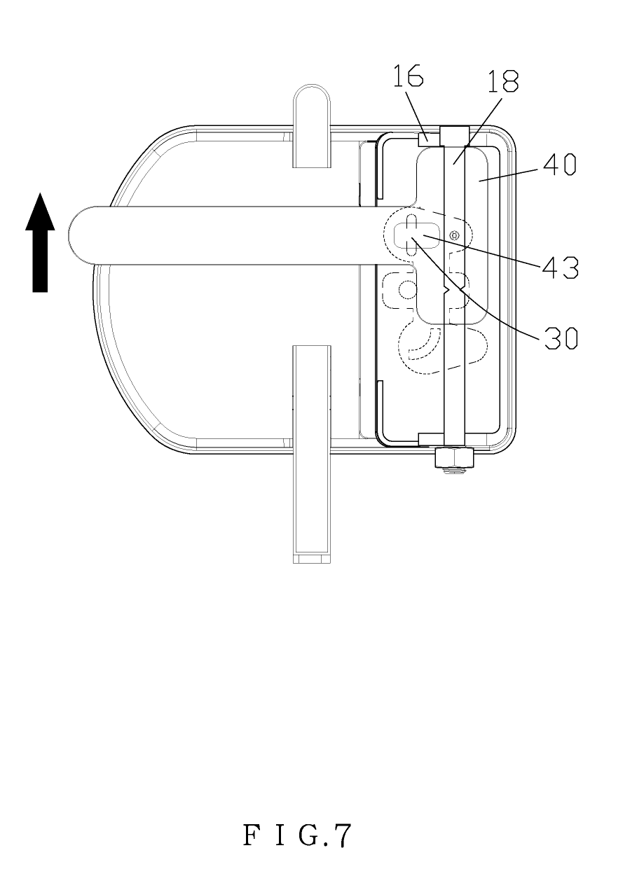

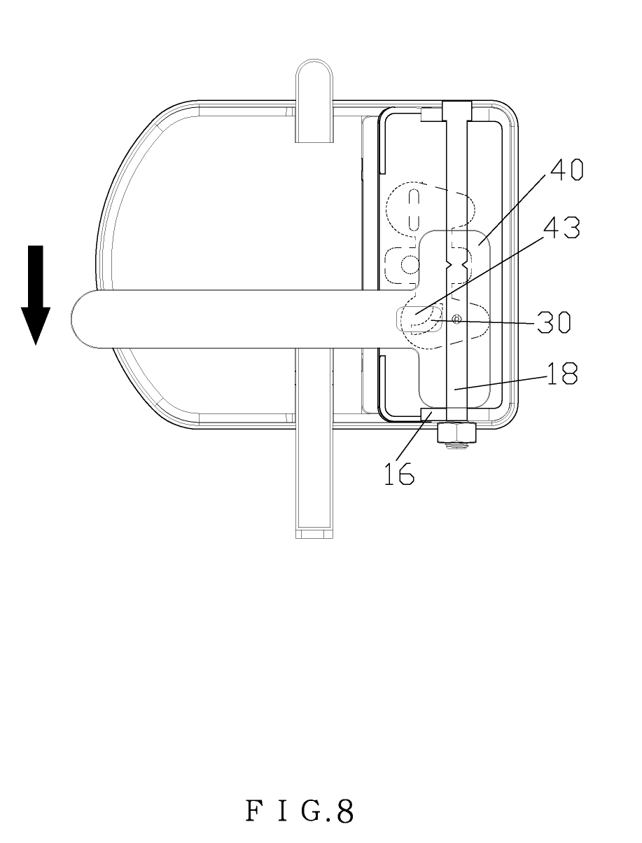

As shown in FIGS. 5-8, the locating element 44 is hollow so as to receive a spring 442, the spring 442 pushes a ball 441 to a mouth of a lower end of the locating element 44, such that when desiring the forcing controller 40 to press one of three columns 30 located between another two columns 30, the ball 442 of the locating element 44 of the forcing controller 40 retains in the trench 181 of the screwing rod 18 so as to position the forcing controller 40. Moreover, when desiring the forcing controller 40 to press the another two columns 30, the forcing controller 40 is pushed to contact with one of the two locking plates 16 so that the abutting member 43 is fixed above the two locking plates 16, and then the forcing controller 40 is moved along the screwing rod 18 so as to align with one of the another two columns 30, thereby punching another two holes on the workpiece.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A punching machine comprising:
a base, a bottom cover disposed on a bottom end of the base, a pressing seat formed on a rear side of the base, a slot defined between a bottom end of a front side of the pressing seat and the base, a stopping recess formed on the base and located in front of the slot;
wherein the stopping recess has an adjustable scale stopper received in the stopping recess;
wherein the punching machine also comprises a holder mounted in the base and located under the pressing seat, wherein the pressing seat has a limiting groove defined thereon, and two locking plates are disposed on two sides of the pressing seat, wherein each locking plates has a first hole, and the holder has an limitation notch defined thereon and corresponding to the limiting groove of the pressing seat and has at least one opening;
wherein the limiting groove has a press device mounted therein and fixed in the imitation notch of the holder, the press device has a first positioning piece disposed in the limitation notch of the holder and has at least one separating block, at least one spacing block, a second positioning piece, and a third positioning piece, wherein the at least one spacing block, the second positioning piece, and the third positioning piece are placed on the first positioning piece;
wherein the first positioning piece has at least one first orifice defined thereon, a respective one of the at least one second positioning piece has an aperture defined thereon, the second positioning piece has at least one second orifice defined thereon, and the third positioning piece has at least one third orifice defined thereon, such that at least screw bolt is inserted through the at least one third orifice, the at least one second orifice, at least three apertures, and the at least one first orifice to screw with at least one first nut, such that the third positioning piece, the second positioning piece the first positioning piece are connected together;
wherein the holder has at least one opening, the first positioning piece has at least one first pore, the second positioning piece has at least one second pore, and the third positioning piece has at least one third pore;
wherein a respective one of at least one column has a shape-varying cross section so as to matching with a shape of each second pore and each third pore and is inserted between the at least one second pore of the second positioning piece and the at least one third pore of the third positioning piece, wherein a respective one of the at least one column has a fixing shaft inserted thereon and has a defining ring fitted on a lower side thereof under the fixing shaft, the defining ring has an eyelet with a varying shape for matching with a shape of a cross section of each column and has a resilient element fitted on a lower side thereof, wherein the each column extends out of a respective one of the at least one third pore;
wherein a forcing controller is defined between the two locking plates, and the forcing controller has a second hole corresponding to two first holes of the two locking plates and is connected with the two locking plates by inserting a screwing rod through the second hole and the two first holes and by screwing the screwing rod with a second nut;
wherein the screwing rod has a trench formed around a central section thereof, and the forcing controller also has an handle extending outwardly from a front end thereof and has an abutting member, the forcing controller further has a locating element.

2. The punching machine as claimed in claim 1, wherein the abutting member is fixed on a bottom end of the forcing controller and moves with the forcing controller to press the each column.

3. The punching machine as claimed in claim 1, wherein a workpiece is placed into the slot, and a height of the at least one separating block is equal to the slot.

4. The punching machine as claimed in claim 1, wherein the at least one opening corresponding to the at least one first pore; the at least one second pore, and the at least one third pore.

5. The punching machine as claimed in claim 1, wherein after releasing the handle, the resilient element pushes the defining ring and the resilient element upwardly, thus returning the at least one column back to an original position.

6. The punching machine as claimed in claim 1, wherein the pressing seat has an upper cover covered thereon.

7. The punching machine as claimed in claim 1, wherein the locating element is disposed on a position of the forcing controller where corresponds to the screwing rod.

8. The punching machine as claimed in claim 1, wherein when desiring the forcing controller to press one of three columns located between another two columns, the ball of the locating element of the forcing controller retains in the trench of the screwing rod so as to position the forcing controller.

9. The punching machine as claimed in claim 1, wherein when desiring the forcing controller to press the another two columns, the forcing controller is pushed to contact with one of the two locking plates so that the abutting member is fixed above the two locking plates.

10. The punching machine as claimed in claim 1, wherein the locating element is hollow so as to receive a spring, the spring pushes a ball to a mouth of a lower end of the locating element.
